(19) United States
(12) Patent Application Publication
(10) Pub. No.: US 2012/0285280 A1
(43) Pub. Date: Nov. 15, 2012

(54) TRANSMISSION ASSEMBLY

(75) Inventor: Chih-Hsien CHANG, Taoyuan Hsien (TW)

(73) Assignee: DELTA ELECTRONICS, INC., Taoyuan Hsien (TW)

(21) Appl. No.: 13/345,900

(22) Filed: Jan. 9, 2012

(30) Foreign Application Priority Data
May 11, 2011 (TW) 100116419

(51) Int. Cl. F16H 35/10; F16H 1/14; F16H 1/12

(52) U.S. Cl. 74/411; 74/416; 74/417

(57) ABSTRACT

A transmission assembly including a frame, driving and driven shafts, driving and driven gears and a knob is provided. The shafts are pivotally connected to the frame, and axes of the driving and driven shafts are intersected mutually. The driving gear is disposed at an end portion of the driving shaft, and the driven gear is disposed at an end portion of the driven shaft to engage with the driving gear. The knob is disposed at another end portion of the driving shaft for receiving torque to conduct the rotation of the driving and driven shafts and the driving and driven gears. When the torque is excessively large, the knob rotates against the driving gear, so the torque will not be transmitted to the gears. Moreover, when the gears are stuck, one of the driving and driven gears can move along the axis to increase backlash therebetween.

This application claims the benefit of the priority to Taiwan Patent Application No. 100116419 filed on May 11, 2011, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention provides a transmission assembly, and more particularly, to a transmission assembly with a gear set.

2. Descriptions of the Related Art

With the widespread use of digital data, projection apparatuses are now used in more places to present digital data. Generally, during the use of a projection apparatus, the location in which an image is projected by the projection apparatus must be firstly adjusted so that the image is completely projected onto a screen.

However, for conventional projection apparatuses, it is not so convenient to adjust the projection location of an image. In detail, to adjust the projection location of the image, the user must move the whole projection apparatus to change the position, height or orientation of the projection apparatus.

Furthermore, in case the projection apparatus is fixed (e.g., suspended from the ceiling), it will be difficult to change the position, height or orientation of the projection apparatus. In such a case, the user can only change the position of the projection screen to project the image onto the projection screen, which is also very inconvenient for the user.

Therefore, an improved solution as disclosed in U.S. Patent Publication No. US 2010/0202067 has been proposed. This improved solution allows the lens module of a projection apparatus to move inside the projection apparatus. When the lens module moves to change the position thereof, the position of an image projected by the lens module also changes correspondingly. In this way, the projection location of the image can be adjusted easily by the user without having to move the whole projection apparatus, and this is particularly suitable for fixed projection apparatuses.

However, there is still room for improvement in terms of this improved solution. In detail, according to this improved solution, the first screw is adapted to rotate under the action of a torque, and a set of bevel gears is used to connect the first screw and second screw. The torque can be transmitted to the second screw via the set of bevel gears to cause rotation of the second screw. In turn, the rotation of the second screw can cause the lens module to move. However, it will be difficult for the second screw to further rotate when the lens module has moved to an extreme position; at this point, if the user continues to apply a torque to the first screw either inadvertently or intentionally, the set of bevel gears might be damaged. Even if the set of bevel gears is not damaged, it might also get stuck, making it difficult to reversibly rotate the set of bevel gears and, consequently, make it difficult to reversibly move the lens module. In other words, the transmission assembly for driving the lens module needs to be improved.

Accordingly, an urgent need exists in the art to provide a transmission assembly capable of overcoming some of the aforesaid shortcomings.

### SUMMARY OF THE INVENTION

The primary objective of the present invention is to provide a transmission assembly capable of preventing damage to the gear set due to excessive stress and preventing the gear set from being stuck.

To achieve the aforesaid objective, the present invention discloses a transmission assembly, which comprises the following: a frame, a driving shaft, a driving gear, a driven shaft, a driven gear and a knob. The driving shaft is pivotally connected to the frame and has a first end portion and a second end portion opposite the first end portion. The driving shaft is defined with a first axis extending through the first end portion and the second end portion. The driving gear is disposed at the first end portion of the driving shaft. The driven shaft is pivotally connected to the frame, and has a third end portion and a fourth end portion opposite the third end portion. The driven shaft is defined with a second axis extending through the third end portion and the fourth end portion, and the second axis intersects with the first axis. The driven gear is disposed at the third end portion of the driven shaft to engage with the driving gear. The knob is disposed at the second end portion of the driving shaft.

The knob is capable of bearing the first torque to drive the driving shaft and the driving gear to rotate about the first axis to drive the driven shaft and the driven gear to rotate about the second axis. The knob rotates with respect to the driving gear when the driven shaft and the driven gear are driven to its dead point and the knob continuously bears the first torque. Either the driving gear or the driven gear generates an axial movement along the first axis or second axis correspondingly when the knob bears a second torque opposite the first torque.

Thereby, when the driven gear and the driven shaft are driven to the dead point and cannot rotate further, the first knob starts to rotate with respect to the driving gear to make it impossible for the first torque to be transmitted to the driving gear. In this way, no force will be further applied by the driving gear to the driven gear that cannot rotate, so damage due to excessive stress will not occur between the driving gear and the driven gear.

In addition, when the second torque is applied to the first knob, the second torque can be transmitted to the driving gear. At the outset, the driving gear and the driven gear might get stuck due to a backlash that is too small therebetween and therefore, cannot rotate. However, by applying an acting force between the driving gear and the driven gear, either the driving gear or the driven gear will be driven to axially move to increase the backlash therebetween. Thus, the driving gear and the driven gear will be able to rotate.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a perspective assembly view of the first preferred embodiment of a transmission assembly according to the present invention;

FIG. 2 is a plan assembly view of the first preferred embodiment of the transmission assembly according to the present invention;

FIG. 3 is a perspective exploded view of the first preferred embodiment of the transmission assembly according to the present invention;

FIG. 4 is a perspective exploded view of the first implementation of the first knob in the first preferred embodiment of the transmission assembly according to the present invention;

FIG. 5 is a cross-sectional plan view of the first implementation of the first knob in the first preferred embodiment of the transmission assembly according to the present invention;

FIG. 6 is a cross-sectional plan view of the second implementation of the first knob in the first preferred embodiment of the transmission assembly according to the present invention;

FIG. 7 is a cross-sectional plan view of an implementation of the first driving shaft in the first preferred embodiment of the transmission assembly according to the present invention;

FIG. 8 is a cross-sectional plan view of another implementation of the first driving shaft in the first preferred embodiment of the transmission assembly according to the present invention;

FIG. 9 is a cross-sectional plan view of an implementation of a driven shaft in the first preferred embodiment of the transmission assembly according to the present invention;

FIG. 10 is a cross-sectional plan view of another implementation of the driven shaft in the first preferred embodiment of the transmission assembly according to the present invention; and

FIG. 11 is a perspective assembly view of the second preferred embodiment of the transmission assembly according to the present invention.

### DESCRIPTION OF THE PREFERRED EMBODIMENT

The present invention provides a transmission assembly, which can receive mechanical energy (torque) and transmit the mechanical energy to an object connected to the transmission assembly to cause movement of the object.

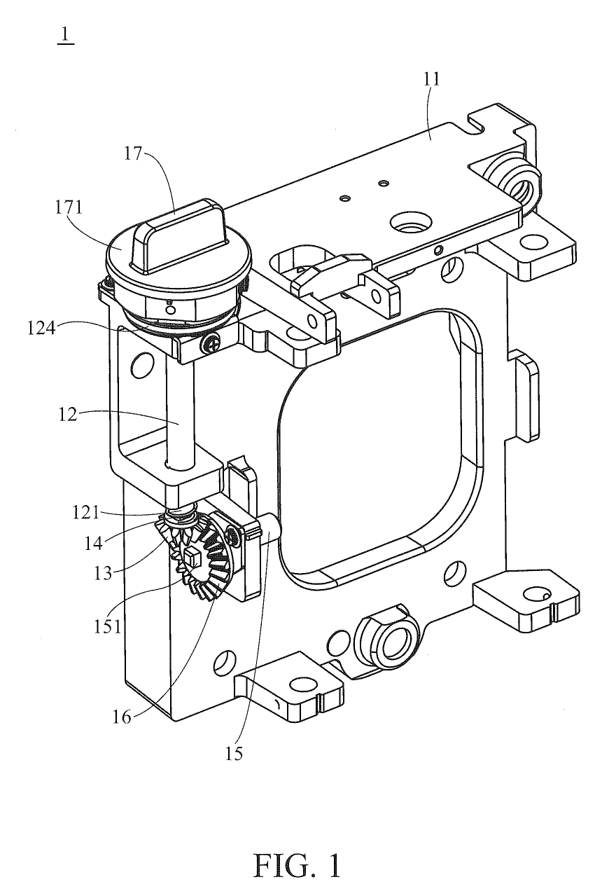

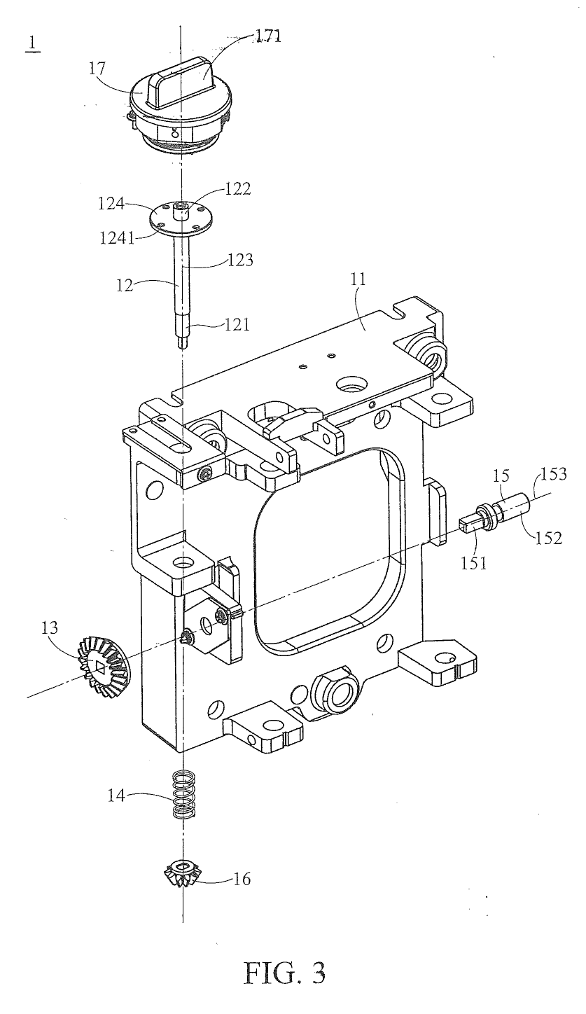

FIGS. 1 to 3 illustrate the perspective assembly view, plan assembly view and perspective exploded view of the first preferred embodiment of a transmission assembly according to the present invention respectively. The transmission assembly 1 of the first preferred embodiment comprises the following: a first frame 11, a first driving shaft 12, a driving gear 13, an elastic component 14, a driven shaft 15, a driven gear 16 and a first knob 17. Hereinafter, the aforesaid components of the transmission assembly 1 will be described sequentially.

The first frame 11 can have the first driving shaft 12 and the driven shaft 15 disposed thereon, and is generally shaped like a plate although the shape thereof may vary depending on the actual application. In addition, the first frame 11 may be a structure integrally formed or a structure consisting of a plurality of components; and in this embodiment, the first frame 11 is a structure integrally formed.

The first driving shaft 12 is pivotally connected to the first frame 11. In detail, the first driving shaft 12 can be retained on the first frame 11 without easily disengaging from the first frame 11, and is adapted to turn (rotate) under the action of a torque. The first driving shaft 12 has a first end portion 121 and a second end portion 122 opposite the first end portion 121, and the second end portion 122 extends above the first frame 11. The first driving shaft 12 is defined with an imaginary first axis 123 extending through the first end portion 121 and the second end portion 122. When the first driving shaft 12 is rotating, it rotates about the first axis 123.

The driving gear 13 is disposed at the first end portion 121 of the first driving shaft 12. In detail, the driving gear 13 is sleeved on, i.e. fitted over, the first end portion 121; because the first end portion 121 has a noncircular cross section and a center hole of the driving gear 13 into which the first end portion 121 that is inserted, also has a noncircular cross section correspondingly. The driving gear 13 and the first end portion 121 cannot rotate with respect to each other but can slide with respect to each other.

It is noted that the definition of a first structure being “sleeved on” a second structure may be that the first structure has a hole, groove or space in which the second portion is inserted. The definition may be applied herein.

The elastic component 14 is also disposed at the first end portion 121 of the first driving shaft 12 and abuts against the driving gear 13. In detail, the elastic component 14 may be a component that can be compressed to store an elastic force such as a spring or a rubber block (and is a spring in this embodiment), and is sleeved on the first end portion 121; the elastic component 14 has an upper end and a lower end. The upper end of the elastic component 14 is fixed with the first end portion 121 without sliding with respect to each other, and the lower end of the elastic component 14 abuts against the driving gear 13. When the driving gear 13 axially moves along the first axis 123 with respect to the first driving shaft 12 under the action of a force, the elastic component 14 is compressed to store an elastic force; and once the force is removed from the driving gear 13, the driving gear 13 can be pushed back to the initial position thereof by the elastic force of the elastic component 14.

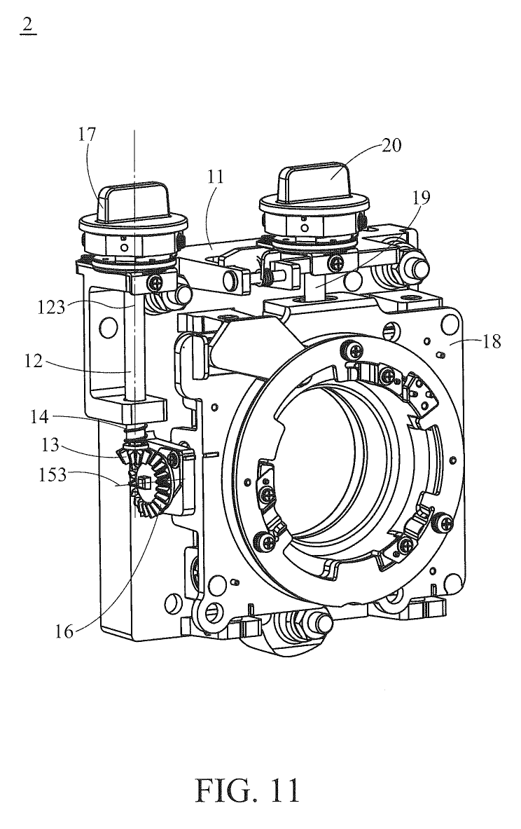

The driven shaft 15 is pivotally connected to the first frame 11. In detail, the driven shaft 15 can be retained on the first frame 11 without easily disengaging from the first frame 11, and can turn (rotate) under the action of a torque. The driven shaft 15 has a third end portion 151 and a fourth end portion 152 opposite the third end portion 151. The third end portion 151 may be located under the first end portion 121 of the first driving shaft 12; and the fourth end portion 152 may be provided with a structure (not shown) such as a thread or a coupler that can be conveniently connected to other components (e.g., a second frame 18 shown in FIG. 11). Furthermore, the driven shaft 15 is defined with an imaginary second axis 153 extending through the third end portion 151 and the fourth end portion 152. When the driven shaft 15 is rotating, it rotates about the second axis 153.

In addition, the second axis 153 is intersected with and substantially perpendicular to the first axis 123. However, in other embodiments, the second axis 153 and the first axis 123 may be intersected non-perpendicularly. It is noted that the phrase “the second axis 153 intersecting with the first axis 123” is defined as follows: suppose there is an imaginary plane (not shown) parallel with both the second axis 153 and the first axis 123; the second axis 153 and the first axis 123 are projected onto the imaginary plane to form a projection line respectively, then the projection line of the second axis 153 is intersected with that of the first axis 123.

The driven gear 16 is disposed at the third end portion 151 of the driven shaft 15. In detail, the driven gear 16 is sleeved on the third end portion 151 without rotation with respect to each other. Furthermore, the driven gear 16 is adapted to engage with the driving gear 13. Because the first axis 123 intersects with the second axis 153, the driven gear 16 and the driving gear 13 each shall be a gear such as a bevel gear or a crossed helical gear (in this embodiment, they are each a bevel gear) to engage with each other.

The first knob 17 is disposed at the second end portion 122 of the first driving shaft 12 and, therefore, can be located above the first frame 11. The first knob 17 is capable of bearing the first torque to drive the first driving shaft 12 and the driving gear 13 to rotate about the first axis 123. Because the driving gear 13 engages with the driven gear 16, the rotation of the driving gear 13 can drive the driven gear 16 and the driven shaft 15 to rotate about the second axis 153; in this way, the first torque applied to the first knob 17 can be transmitted to the driven shaft 15. Then, when the driven shaft 15 is connected to a driven part (not shown), the first torque can be transmitted to the driven part so that the driven part can move (rotate or shift).

The driven shaft 15 and the driven gear 16 can continuously rotate in the same direction (either counter-clockwise or clockwise) until reaching a dead point; then, it will be difficult for the driven shaft 15 and the driven gear 16 to rotate anymore in the same direction. The dead point may be generated by the transmission assembly 1 itself or by the driven part. In detail, if the dead point is generated by the transmission assembly 1 itself, then a portion of the driven shaft 15 (or the first driving shaft 12) will come into contact with the first frame 11 when rotating to a particular angle so that the driven shaft 15 cannot rotate anymore in the same direction; if the dead point is generated by the driven object, then a portion of the driven object will come into contact with the first frame 11 or other fixed parts, so that the driven object cannot move further and the driven shaft 15 connected to the driven object cannot rotate further either.

Regardless of how the dead point is generated, it is inappropriate for the first knob 17 to bear the first torque of the same direction any longer when the driven shaft 15 and the driven gear 16 rotate to the dead point; otherwise, this would cause damage to the driving gear 13 and the driven gear 16. However, sometimes it is possible for the user to still put the first knob 17 continuously under the first torque either inadvertently or intentionally.

To avoid damage to the driving gear 13 and the driven gear 16, the following mechanism is adopted in this embodiment: before the driven shaft 15 and the driven gear 16 rotate to the dead point, the first torque applied to the first knob 17 can be transmitted to the driving gear 13; and if the first knob 17 still continuously bears the first torque when the driven shaft 15 and the driven gear 16 have rotated to the dead point, the first knob 17 can rotate with respect to the driving gear 13 so that the first torque applied to the first knob 17 cannot be transmitted to the driving gear 13.

The aforesaid mechanism of preventing damage of the gears can be accomplished by the first knob 17. Hereinafter, implementations of the first knob 17 will be illustrated.

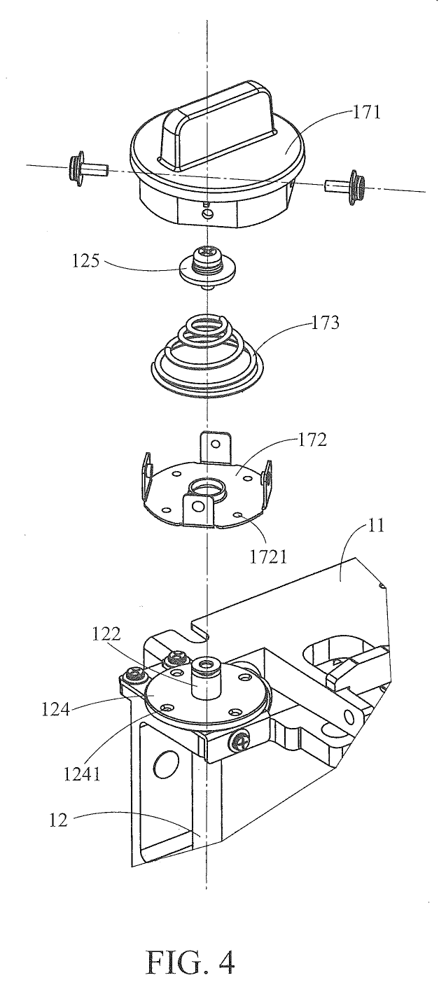

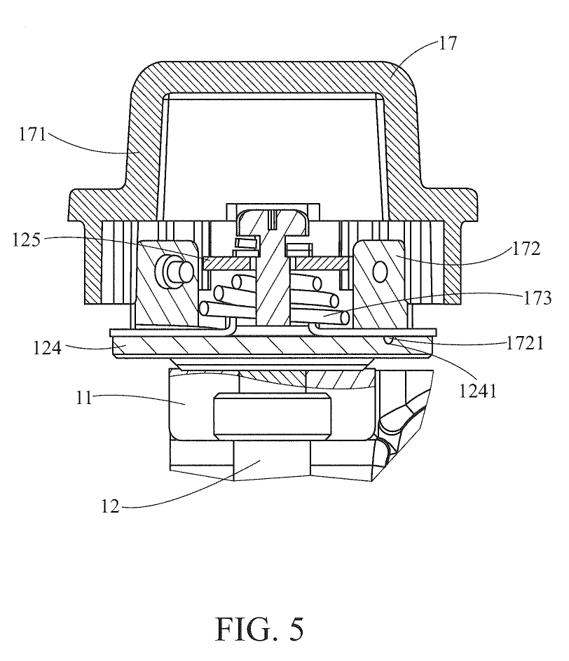

FIGS. 4 and 5 illustrate a perspective exploded view and a cross-sectional plan view of the first implementation of the first knob in the first preferred embodiment of the transmission assembly according to the present invention respectively. The first knob 17 may comprise a shell 171, a contact piece 172 and an elastic component 173. The shell 171 is fixedly connected to the contact piece 172, so the shell 171 and the contact piece 172 can rotate synchronically. The shell 171 may be designed in a form that is convenient for the user to hold and to apply a force thereon. The contact piece 172 and the elastic component 173 are sleeved on the second end portion 122 of the first driving shaft 12.

To cooperate with the first knob 17, the first driving shaft 12 is integrally formed, and the second end portion 122 is additionally provided with a first plate 124 and a second plate 125 spaced apart from the first plate 124. The first plate 124 and the second plate 125 are fixed to the second end portion 122 respectively. The contact piece 172 is located between the first plate 124 and the second plate 125, and comes into contact but is not fixed to the first plate 124; therefore, the contact piece 172 can rotate and slide with respect to the first plate 124. The elastic component 173 is located between the contact piece 172 and the second plate 125 to be compressed by the contact piece 172 and the first plate 124. When being compressed, the elastic component 173 will apply a force to the contact piece 172 so that a large static friction force can be generated between the contact piece 172 and the first plate 124.

Because of the static friction force between the contact piece 172 and the first plate 124, the contact piece 172 can drive the first plate 124 to rotate when the first torque is applied to the shell 171 of the first knob 17 so that the first driving shaft 12, the driving gear 13, the driven shaft 15 and the driven gear 16 rotate too. When the driven shaft 15 and the driven gear 16 rotate to the dead point, the first torque applied to the shell 171 of the first knob 17 increases to beyond the static friction force between the contact piece 172 and the first plate 124; consequently, the contact piece 172 will rotate and slide with respect to the first plate 124. Thus, it will be difficult for the first torque to be transmitted to the driving gear 13, and no acting force will exist between the driving gear 13 and the driven gear 16.

Furthermore, the first plate 124 may further be annularly formed with a plurality of recesses 1241, and the contact piece 172 may further be annularly formed with a plurality of bosses 1721 which can be detachably located within the recesses 1241 respectively. The bosses 1721 located within the recesses 1241 can assist the contact piece 172 in driving the first plate 124 to rotate. When the contact piece 172 rotates with respect to the first plate 124, each of the bosses 1721 will move out of a current recess 1241 into another recess 1241. A sound is made when the bosses 1721 move out of and into the corresponding recesses 1241 to inform the user that the driven shaft 15 has rotated to the dead point.

It is noted that, if the static friction force between the contact piece 172 and the first plate 124 is already sufficient for the contact piece 172 to drive the first plate 124, then it will be unnecessary to provide the bosses 1721 and the recesses 1241.

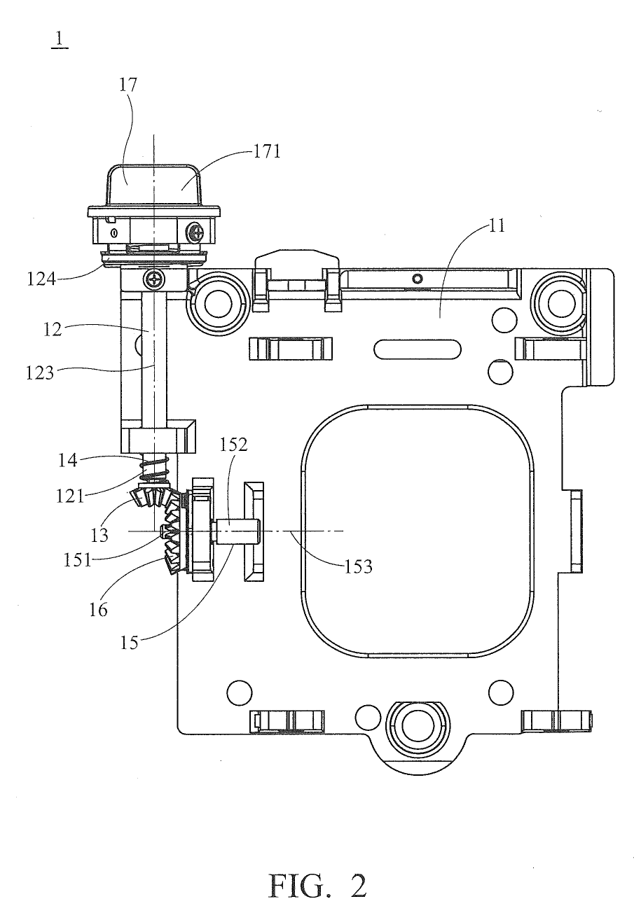

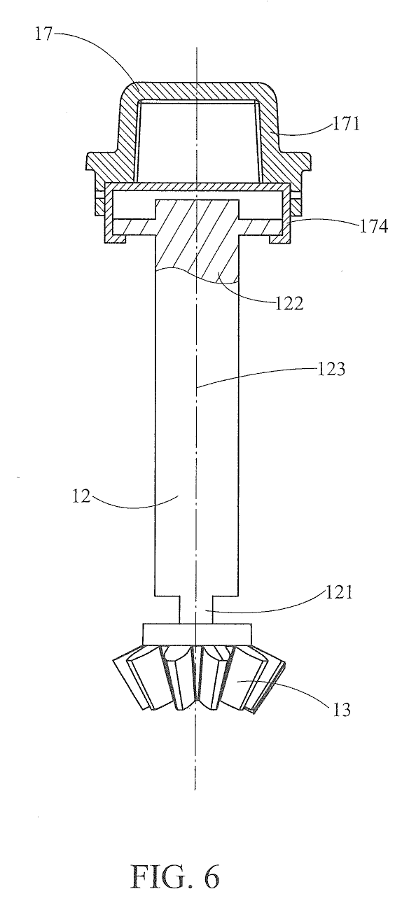

Referring to FIG. 6 and FIG. 2 together, FIG. 6 illustrates the cross-sectional plan view of a second implementation of the first knob in the first preferred embodiment of the transmission assembly according to the present invention. The first knob 17 in this implementation may comprise a shell 171 and another contact piece 174. The shell 171 is fixedly connected to the contact piece 174, and the contact piece 174 is sleeved on the second end portion 122 of the first driving shaft 12. The first plate 124 at the second end portion 122 is clamped by the contact piece 174 so that a sufficient static friction force is generated between the contact piece 174 and the first plate 124.

When the first torque is applied to the first knob 17, the contact piece 174 can drive the first plate 124 to rotate by means of the static friction force between the contact piece 174 and the first plate 124. When the driven shaft 15 and the driven gear 16 rotate to the dead point, the first torque will cause the contact piece 174 to rotate with respect to the first plate 124. Thus, it will be impossible for the first torque to be transmitted to the driving gear 13, so damage of the driving gear 13 and the driven gear 16 is avoided.

Apart from being accomplished by the first knob 17, the mechanism of preventing damage to the gears may further be accomplished by the first driving shaft 12, which will be detailed as follows.

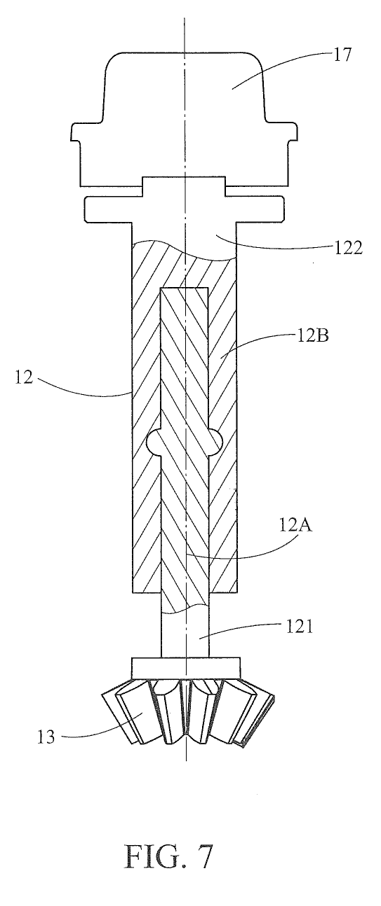

Referring to FIG. 7 and FIG. 2 together, FIG. 7 is a cross-sectional plan view of an implementation of the first driving shaft in the first preferred embodiment of the transmission assembly according to the present invention. The first driving shaft 12 is not integrally formed, but is divided into two parts. In other words, the first driving shaft 12 comprises a first part 12A having the first end portion 121 and a second part 12B having the second end portion 122. The second part 12B is formed with a hole for the first part 12A to be inserted therein. The first part 12A and the second part 12B may be assembled in an interference fit manner so that a static friction force is generated between the first part 12A and the second part 12B. Furthermore, the first knob 17 is fixedly connected to the second end portion 122, so the first knob 17 and the second end portion 122 (the second part 12B) can rotate synchronically.

When the first torque is applied to the first knob 17, the first torque can be directly transmitted to the second part 12B; and then by means of the static friction force between the first part 12A and the second part 12B, the second part 12B can drive the first part 12A to rotate so that the driving gear 13, the driven gear 16 and the driven shaft 15 rotate too. If the first torque is still continuously applied to the first knob 17 when the driven shaft 15 and the driven gear 16 has rotated to the dead point, the first torque will increase to beyond the static friction force between the first part 12A and the second part 12B, thus causing the second part 12B to rotate and slide with respect to the first part 12A. Thus, it will be difficult for the first torque to be transmitted to the driving gear 13, so no acting force will exist between the driving gear 13 and the driven gear 16.

In addition to the mechanism of preventing damage of the gears, this embodiment further discloses a mechanism of preventing the gears from getting stuck, which will be detailed as follows.

In reference back to FIGS. 1 and 2, when the driven gear 16 and the driven shaft 15 rotate to the dead point under the action of the first torque, a second torque opposite to the first torque must be applied to the first knob 17 to allow the driving gear 13 to drive the driven gear 16 and the driven shaft 15 to rotate in reverse away from the dead point. However, when starting to rotate reversely, the driving gear 13 and the driven gear 16 may get stuck due to a backlash that is too small therebetween, which makes it difficult for the driving gear 13 and the driven gear 16 to successfully rotate reversely.

Therefore, the driving gear 13 of this embodiment is disposed in such a way that it can axially move along the first axis 123 with respect to the first driving shaft 12. Thus, in case the driving gear 13 and the driven gear 16 get stuck, the acting force between the driving gear 13 and the driven gear 16 can force the driving gear 13 to axially move away from the driven gear 16 to increase the backlash between the driving gear 13 and the driven gear 16. As the backlash is increased, the driving gear 13 and the driven gear 16 will not be stuck and can successfully rotate reversely.

In this embodiment, there are also other types of mechanisms of preventing the gears from getting stuck, which will be described as follows.

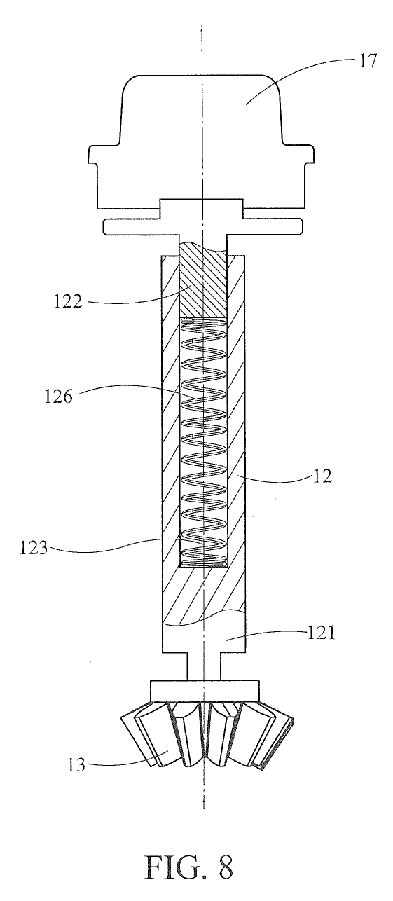

Referring to FIG. 8 and FIG. 2 together, FIG. 8 is a cross-sectional plan view of another implementation of the first driving shaft in the first preferred embodiment of the transmission assembly according to the present invention. The first driving shaft 12 further has an elastic component 126, which is disposed between the first end portion 121 and the second end portion 122 so that the first end portion 121 can move along the first axis 123 with respect to the second end portion 122. The driving gear 13 is fixed to the first end portion 121.

In case the driving gear 13 and the driven gear 16 get stuck, the acting force between the driving gear 13 and the driven gear 16 can allow the driving gear 13 to axially move together with the first end portion 121 along the first axis 123 with respect to the second end portion 122 (away from the driven gear 16). The axial movement of the driving gear 13 will increase the backlash between the driving gear 13 and the driven gear 16 to prevent the driving gear 13 and the driven gear 16 from being stuck.

As can be known from the above descriptions, the sticking of the gears can be prevented as long as the driving gear 13 can axially move away from the driven gear 16. Similarly, if the driven gear 16 can axially move away from the driving gear 13, then the sticking of the gears can also be prevented. The implementations of which will be described as follows.

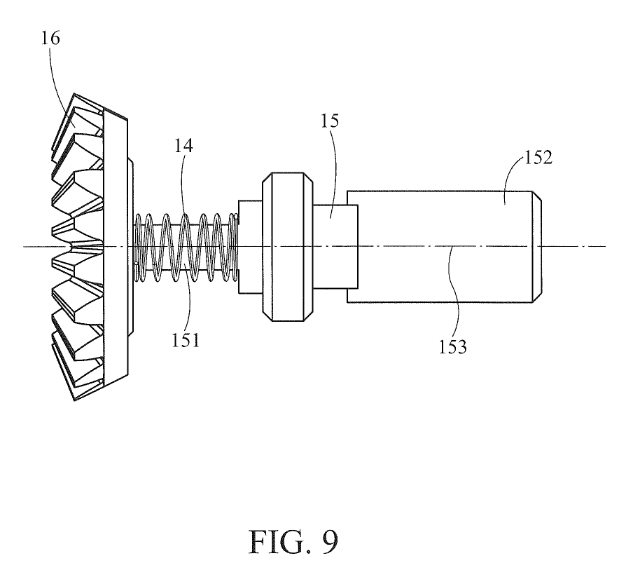

Referring to FIG. 9 and FIG. 2 together, FIG. 9 is a schematic plan view of an implementation of the driven shaft in the first preferred embodiment of the transmission assembly according to the present invention. The elastic component 14 is disposed on the third end portion 151 of the driven shaft 15 instead and abuts against the driven gear 16. Thus, the driven gear 16 can axially move along the second axis 153 with respect to the driven shaft 15 to prevent the gears from being stuck.

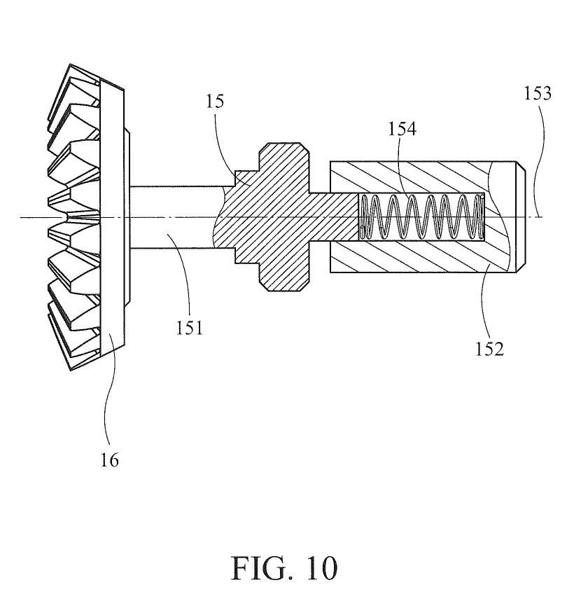

Referring to FIG. 10 and FIG. 2 together, FIG. 10 is a cross-sectional plan view of another implementation of the driven shaft in the first preferred embodiment of the transmission assembly according to the present invention. Similar to the driving shaft 12 in FIG. 8, the driven shaft 15 also has an elastic component 154 disposed between the third end portion 151 and the fourth end portion 152. The driven gear 16 is fixed to the third end portion 151 so that the driven gear 16 can axially move together with the third end portion 151 along the second axis 153 with respect to the fourth end portion 152.

FIG. 11 illustrates the perspective assembly view of the second preferred embodiment of the transmission assembly according to the present invention. As compared with the transmission assembly 1 of the first preferred embodiment, the transmission assembly 2 of the second preferred embodiment further comprises a second frame 18, a second driving shaft 19 and a second knob 20; the transmission assembly 2 can be used to adjust the position of a lens module (not shown) of a projection apparatus.

The second frame 18 is connected to the driven shaft 15, and the lens module may be disposed on the second frame 18. The second driving shaft 19 is pivotally connected to the first frame 11 and extends in parallel with the first axis 123; that is, an axis (not shown) of the second driving shaft 19 is in parallel with the first axis 123. The second driving shaft 19 has two end portions (an upper end portion and a lower end portion) connected to the second frame 18 and the second knob 20 respectively.

When the first torque is applied to the first knob 17, the driven shaft 15 can rotate about the second axis 153 to drive the second frame 18 to move along the second axis 153. When a third torque is applied to the second knob 20, the second driving shaft 19 can rotate to drive the second frame 18 to move along the first axis 123. For detailed implementations of the second frame 18 and the second driving shaft 19, reference may be made to U.S. Patent Publication No. US 2010/0202067.

In addition, it will be difficult for the second driving shaft 19 to rotate further when having rotated to a dead point. At this point, if the third torque of the same direction is still continuously applied to the second knob 20, the second driving shaft 19 might be damaged. To avoid this, the second knob 20 may be disposed like the first knob 17 in such a way that the second knob 20 can rotate with respect to the second driving shaft 19 as the third torque increases.

According to the above descriptions, the transmission assembly of the present invention provides a plurality of mechanisms of preventing damage to the gears or transmission shafts and a plurality of mechanisms of preventing the gears from getting stuck; these qualities makes the transmission assembly of the present invention more reliable to use.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A transmission assembly, comprising:
a first frame;
a first driving shaft pivotally connected to the first frame, the first driving shaft having a first end portion and a second end portion opposite to the first end portion, wherein the first driving shaft is defined with a first axis extending through the first end portion and the second end portion;
a driving gear disposed at the first end portion of the first driving shaft;
a driven shaft pivotally connected to the first frame, the driven shaft having a third end portion and a fourth end portion opposite to the third end portion, wherein the driven shaft is defined with a second axis extending through the third end portion and the fourth end portion, and the second axis is intersected with the first axis;
a driven gear disposed at the third end portion of the driven shaft to engage with the driving gear; and
a first knob disposed at the second end portion of the first driving shaft,
wherein the first knob is capable of bearing a first torque to drive the first driving shaft and the driving gear to rotate about the first axis, so as to drive the driven shaft and the driven gear to rotate about the second axis;
wherein the first knob rotates with respect to the driving gear when the driven shaft and the driven gear are driven to a dead point and the first knob continuously bears the first torque, and at least one of the driving gear and the driven gear generates an axial movement along the first axis or the second axis correspondingly when the first knob bears a second torque opposite to the first torque.

2. The transmission assembly of claim 1, further comprising an elastic component disposed on the first end portion of the first driving shaft to abut against the driving gear, so that the driving gear is capable of axially moving along the first axis with respect to the first driving shaft.

3. The transmission assembly of claim 1, wherein the first driving shaft further has an elastic component disposed between the first end portion and the second end portion, so that the driving gear is capable of axially moving together with the first end portion along the first axis with respect to the second end portion.

4. The transmission assembly of claim 1, further comprising an elastic component disposed on the third end portion of the driven shaft to abut against the driven gear, so that the driven gear is capable of axially moving along the second axis with respect to the driven shaft.

5. The transmission assembly of claim 1, wherein the driven shaft further has an elastic component disposed between the third end portion and the fourth end portion, so that the driven gear is capable of axially moving together with the third end portion along the second axis with respect to the fourth end portion.

6. The transmission assembly of claim 1, wherein the second end portion of the first driving shaft is provided with a first plate, and the first knob includes a shell and a contact piece being fastened to the shell and sleeved on the first driving shaft to contact with the first plate, wherein the contact piece is capable of driving the first plate to rotate the first driving shaft when the first knob bears the first torque, and the shell and the contact piece rotate with respect to the first plate when the driven shaft and the driven gear are driven to the dead point while the first knob continuously bearing the first torque.

7. The transmission assembly of claim 6, wherein the second end portion of the first driving shaft is further provided with a second plate spaced apart from the first plate with the contact piece being disposed between the first plate and the second plate, and the first knob further comprises an elastic component disposed between the contact piece and the second plate for bearing compression from the contact piece and the second plate.

8. The transmission assembly of claim 7, wherein the first plate is annularly formed with a plurality of recesses, and the contact piece is annularly formed with a plurality of bosses detachably located within the recesses respectively.

9. The transmission assembly of claim 6, wherein the contact piece and the first plate form a static friction force therebetween.

10. The transmission assembly of claim 1, wherein the first driving shaft further comprises a first part and a second part, in which the first part has the first end portion and the second part has the second end portion, and the second part is sleeved on the first part, wherein the first part drives the second part to rotate when the first knob bears the first torque, and the second part rotates with respect to the first part when the driven shaft and the driven gear are driven to the dead point while the first knob continuously bearing the first torque.

11. The transmission assembly of claim 10, wherein the first part and the second part form a static friction force therebetween.

12. The transmission assembly of claim 1, further comprising a second frame connected to the driven shaft, wherein the driven shaft operatively drives the second frame to move along the second axis when the driven shaft and the driven gear rotate about the second axis.

13. The transmission assembly of claim 12, further comprising a second driving shaft and a second knob, wherein the second driving shaft pivotally connects to the first frame and extends parallel with the first axis, the second driving shaft has two end portions connected to the second frame and the second knob respectively, and the second knob is capable of bearing a third torque to drive the second driving shaft to rotate, so that the second driving shaft is capable of driving the second frame to move along the first axis when the second driving shaft rotates.

14. The transmission assembly of claim 13, wherein the second knob rotates with respect to the second driving shaft when the second driving shaft rotates to another dead point and the second knob continuously bears the third torque.

15. The transmission assembly of claim 1, wherein the second axis is substantially perpendicular to the first axis.

16. The transmission assembly of claim 1, wherein each of the driving gear and the driven gear is a bevel gear or a crossed helical gear.
